(19) United States
(12) Patent Application Publication
(10) Pub. No.: US 2004/0185992 A1
(43) Pub. Date: Sep. 23, 2004

(54) Method and apparatus for making a packaging article and packaging article made by the method and apparatus

(76) Inventor: Lucien E. Tisdale, Monroe, LA (US)

Correspondence Address: RATNERPRESTIA, P O BOX 980, VALLEY FORGE, PA, 19482-0980, US

(21) Appl. No.: 10/390,799

(22) Filed: Mar. 18, 2003

(51) Int. Cl. B31B 5/14

(52) U.S. Cl. 493/56

(57) ABSTRACT

A packaging article is made from two sheets, a first one being slit along a line extending along its length to form two sections that are separated and, with the separation between sections of the first sheet maintained, attached to the second sheet. A groove between the two sections of the first sheet accommodates the thickness of the sections of the first sheet as the second sheet is folded along a line extending along the separation between the two sections of the first sheet. The folded assembly is cut transversely to selected lengths.

### TECHNICAL FIELD

The present invention relates, in general, to packaging articles and the way such articles are made and, in particular, to a multiply packaging article and its formation.

### BACKGROUND OF THE INVENTION

U.S. Pat. No. 4,685,610 describes a multi-sheet packaging and shipping container and a method and apparatus for forming the particular container. A first sheet is slit along its length to form two sections that are separated by a wedge along the slit line a predetermined distance transverse to the length of the first sheet. The sections of the first sheet are attached to a second sheet to form an assembly with the sections of the first sheet separated and defining a groove. After the two sheets are attached, the assembly is folded along the groove, with that part of the second sheet aligned with the groove acting as a hinge. The width of the groove is intended to accommodate the thickness of the separated sections of the first sheet as they are brought together during the step of folding. Subsequently, the folded assembly is cut transverse to its length to produce products of desired length. Depending on the design of the product, the first sheet can be slit into more than two sections resulting in adjacent sections of the first sheet being separated.

It has been found that, in practicing the method disclosed in U.S. Pat. No. 4,685,610 with the equipment disclosed in this patent, the desired separation of the sections of the first sheet is not consistently maintained. Under certain conditions, the separation of the sections of the first sheet, developed by wedges acting on the sections of the first sheet, might be reduced. The nature and characteristics of the sheets and the manner in which the wedges act on the sections of the first sheet are factors that affect reductions in the separation of the sections of the first sheet.

Reductions in the separation of the sections of the first sheet result in grooves that vary in width along the length of the groove when constant groove width is desired or variations in groove width from one groove to another in the same multi-fold product when the same groove width is desired. Such undesirable results affect the accommodation by the grooves of the thickness of each of the separated sections of the first sheet as the sections are brought together during the step of folding. With inadequate groove width, one or both of the two sections being brought together during folding will not be received properly, thereby affecting the quality of the fold.

This is particularly a problem with thicker products (e.g., more than .160 caliper) and products having more than two grooves (e.g., multi-fold products such as tubes of triangular or square cross-section). Compensating for inadequate groove width, for example, by over-separating the two sections of the first sheet, is not an acceptable solution because not all separations reduce to such an extent that the groove will not accommodate the thickness of each of the separated sections of the first sheet. When there is no reduction in separation, the groove, developed from over-separated sections of the first sheet, will be too wide, thereby affecting the quality of the fold in an opposite sense.

### SUMMARY OF THE INVENTION

A packaging article is formed, in accordance with the present invention, by supplying a first sheet and providing a second sheet and moving the first sheet along a path extending along the length of the first sheet and moving the second sheet along a path extending along the length of the second sheet. A slit is made through the first sheet along a line extending along the length of the first sheet to form two sections from the first sheet. The section of the first sheet are separated a predetermined distance transverse to the length of the first sheet and the separation of the two sections of the first sheet is maintained. The first sheet is attached to the second sheet with the predetermined separation between the two sections of first sheet.

### BRIEF DESCRIPTION OF THE DRAWING

FIG. 1 is a schematic drawing of apparatus for making a packaging article in accordance with the present invention.

FIG. 2 is a side view of a portion of apparatus for making a packaging article in accordance with the present invention.

FIG. 3 is a perspective view of a bow roll used in apparatus for making a packaging article in accordance with the present invention.

FIG. 4A is a perspective view of a partially folded packaging article made in accordance with the present invention.

FIG. 4B is a perspective view of the FIG. 4A packaging article after it has been folded completely.

### DETAILED DESCRIPTION OF THE INVENTION

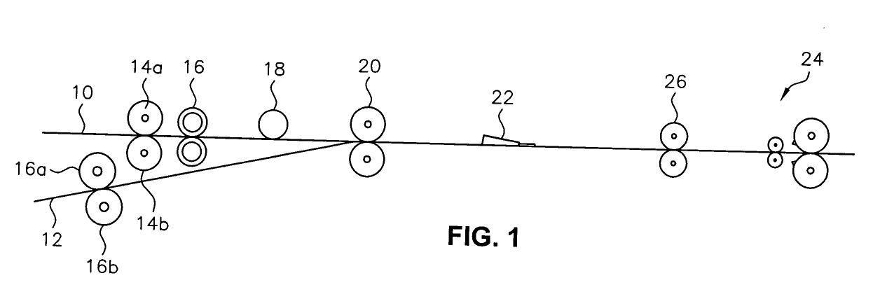

Referring to FIG. 1, apparatus for making a packaging article, constructed in accordance with the present invention, includes means for supplying a first sheet 10 and a second sheet 12 and means for moving first sheet 10 along a path extending along the length of first sheet 10 and for moving second sheet 12 along a path extending along the length of second sheet 12. First sheet 10 can be a multiply panel supplied through a pair of rollers 14a and 14b from continuous supply rolls (not shown). Likewise, second sheet 12 can be a multiply panel supplied through a pair of rollers 16a and 16b from continuous supply rolls (not shown).

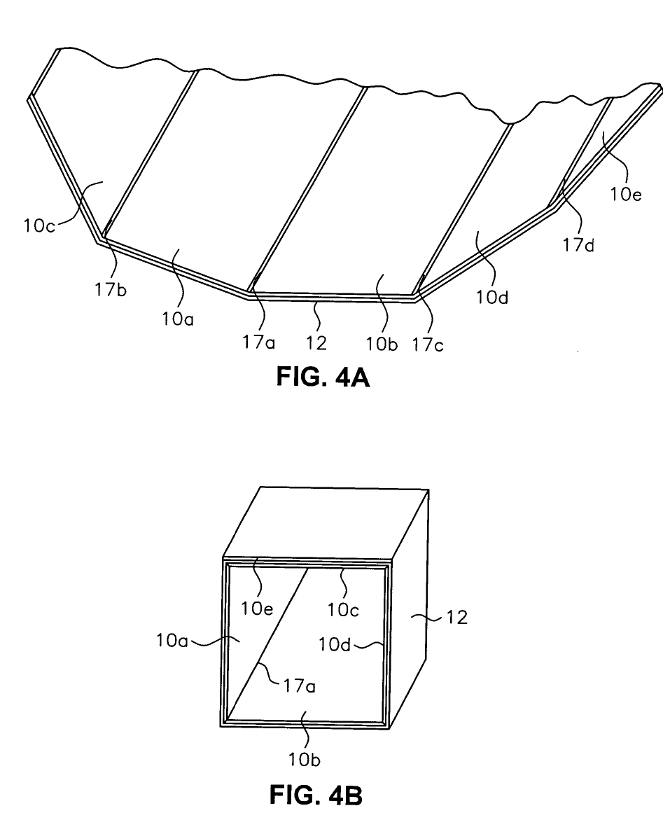

The apparatus of FIG. 1 also includes means for slitting first sheet 10 into two sections 10a and 10b, shown in FIG. 4A, along a line 17a extending along the length of the first sheet. The slitting of sheet 10 can be done by a cutter 16 of conventional construction and operation. The design of the packaging article defines the number of slits made to first sheet 10 and the number of resulting sections of the first sheet. For the product shown in FIG. 4A, three additional sections 10c, 10d, and 10e are developed by three additional slits 17b, 17c, and 17d made to first sheet 10. When additional slits are to be made, additional cutters, similar to cutter 16, are needed.

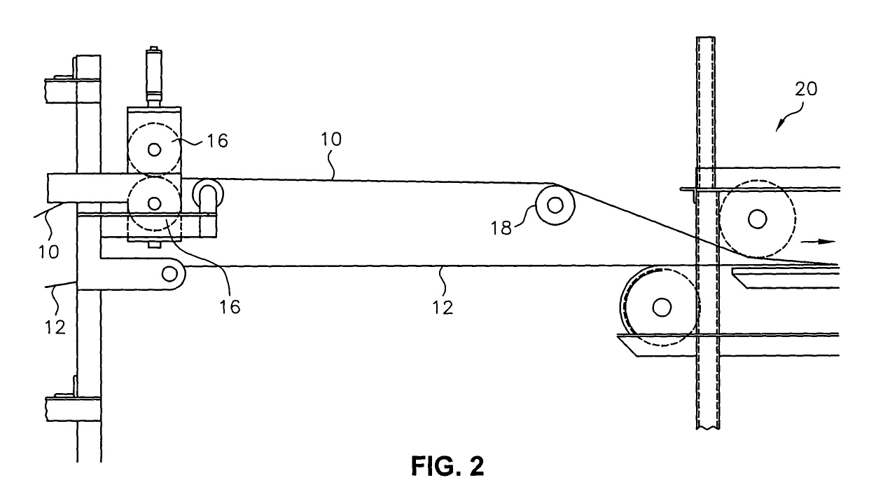

After first sheet 10 is slit into two or more sections, the sections of the first sheet are separated a predetermined distance transverse to the length of the first sheet. Such means include a spreading member 18 that is in the path of movement of first sheet 10 and has a curved shape that extends transverse to the path of movement of the first sheet. Spreading member 18 is arranged so that the sections of first sheet 10, conforming to the curvature of the spreading member, are in contact with the spreading member from one edge of first sheet to the opposite edge of the first sheet, with the result that the predetermined separations of the sections of the first sheet are maintained. FIG. 2 shows a portion of the FIG. 1 apparatus with a spreading member 18 mounted by suitable means (not shown) downstream of a cutter 16.

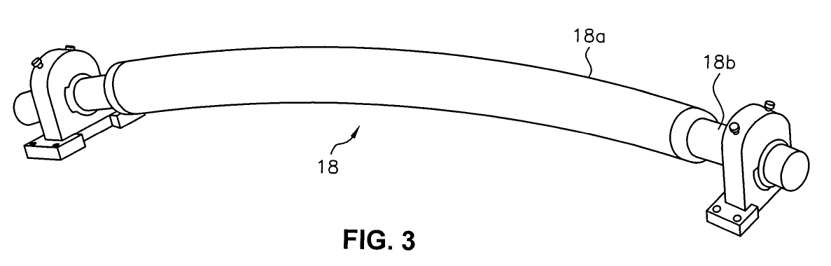

Preferably, spreading member 18 is a bow roll, such as one sold by the Mount Hope company and illustrated in FIG. 3. Such a unit is symmetrically curved along its axis. The roll 18a has a constant diameter along its entire face length and is free turning about a non-rotating fixed axle 18b. The turning force is provided by a continuous sheet or web, such as first sheet 10, that passes over the surface of the roll or by a drive sheave mounted on the end of the roll. The desired separations of the sections of the first sheet are established and maintained by the selected rotation angle over which the first sheet remains in contact with roll 18a of the bow roll.

Although one bow roll has been found to be sufficient to spread the sections of first sheet 10 the desired distance and maintain the desired separation, additional bow rolls, if needed, can be included.

The FIG. 1 apparatus also includes means for attaching the sections of first sheet 10 to second sheet 12, with the predetermined separation between the sections of first sheet 10. The two sheets can be attached in the usual way by gluing them together with a suitable adhesive at a laminating station 20 of conventional construction and operation. FIG. 4A shows sections 10a, 10b, 10c, 10d, and 10e of first sheet 10 attached to sheet 12, with grooves, formed from slits 17a, 17b, 17c, and 17d, between adjacent sections of first sheet 10.

Apparatus for making a packaging article, constructed in accordance with the present invention, further includes means for folding second sheet 12 along a line extending along the predetermined separation between adjacent sections of first sheet 10 and means for cutting transverse to the path of movement of first sheet 10 and second sheet 12 selected lengths of the sections of the first sheet and the second sheet. The folding operation can be performed at a folding station of conventional construction and operation, represented and identified by reference numeral 22 and the transverse cutting operation can be performed by transverse slitter 24 of conventional construction and operation. Pulling rollers, such as those identified by reference numeral 26, are included in the FIG. 1 apparatus to facilitate movement of sheets 10 and 12.

FIG. 4B illustrate a typical packaging article made in accordance with the present invention after sheets 10 and 12 have been attached, folded, and cut transversely.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for making a packaging article comprising the steps of:
supplying a first sheet and a second sheet;
moving said first sheet along a path extending along the length of said first sheet and said second sheet along a path extending along the length of said second sheet;
making a slit through said first sheet along a line extending along the length of said first sheet to form two sections from said first sheet;
separating and maintaining separation of said two sections of said first sheet a predetermined distance transverse to the length of said first sheet; and
attaching said two sections of said first sheet to said second sheet with the predetermined separation between said two sections of said first sheet.

2. A method for making a packaging article according to claim 1 further including the steps of:
(a) folding said second sheet along a line extending along the predetermined separation between said two sections of said first sheet, and
(b) cutting transverse to the path of movement of said first sheet and said second sheet after attachment of said sections of said first sheet to said second sheet selected lengths of said sections of said first sheet and said second sheet.

3. A method for making a packaging article according to claim 2 wherein said first sheet is a multiply panel and said second sheet is a multiply panel.

4. A method for making a packaging article comprising the steps of:
supplying a first sheet and a second sheet;
moving said first sheet along a path extending along the length of said first sheet and said second sheet along a path extending along the length of said second sheet;
making a plurality of slits through said first sheet along lines extending along the length of said first sheet to form a plurality of sections from said first sheet;
separating and maintaining separation of adjacent sections of said first sheet a predetermined distance transverse to the length of said first sheet; and
attaching said sections of said first sheet to said second sheet with the predetermined separation between adjacent sections of said first sheet.

5. A method for making a packaging article according to claim 4 further including the steps of:
(a) folding said second sheet along a lines extending along the predetermined separations between said sections of said first sheet, and
(b) cutting transverse to the paths of movement of said first sheet and said second sheet after attachment of said sections of said first sheet to said second sheet selected lengths of said sections of said first sheet and said second sheet.

6. A method for making a packaging article according to claim 5 wherein said first sheet is a multiply panel and said second sheet is a multiply panel.

7. Apparatus for making a packaging article comprising:
means for supplying a first sheet and a second sheet;
means for moving said first sheet along a path extending along the length of said first sheet and said second sheet along a path extending along the length of said second sheet;
means for slitting said first sheet into two sections along a line extending along the length of said first sheet;
means for separating and maintaining separation of said two sections of said first sheet a predetermined distance transverse to the length of said first sheet; and
means for attaching said two sections of said first sheet to said second sheet with the predetermined separation between said two sections of said first sheet.

8. Apparatus for making a packaging article according to claim 7 further including:
(a) means for folding said second sheet along a line extending along the predetermined separation between said two sections of said first sheet, and
(b) means for cutting transverse to the path of movement of said first sheet and said second sheet selected lengths of said sections of said first sheet and said second sheet.

9. Apparatus for making a packaging article according to claim 8 wherein said means for separating and maintaining separation of said two sections of said first sheet include a spreading member:
(a) in the path of movement of said first sheet,
(b) having a curved shape extending transverse to the path of movement of said first sheet, and
(c) with which said sections of said first sheet are in contact from one edge of said first sheet to the opposite edge of said first sheet.

10. Apparatus for making a packaging article according to claim 9 wherein said spreading member is a bow roll.

11. Apparatus for making a packaging article comprising:
means for supplying a first sheet and a second sheet;
means for moving said first sheet along a path extending along the length of said first sheet and said second sheet along a path extending along the length of said second sheet;
means for slitting through said first sheet along a plurality of lines extending along the length of said first sheet to form a plurality of sections from said first sheet;
means for separating and maintaining separation of adjacent sections of said first sheet a predetermined distance transverse to the length of said first sheet; and
means for attaching said sections of said first sheet to said second sheet with the predetermined separation between adjacent sections of said first sheet.

12. Apparatus for making a packaging article according to claim 11 further including:
(a) means folding said second sheet along a lines extending along the predetermined separations between said sections of said first sheet, and
(b) means for cutting transverse to the paths of movement of said first sheet and said second sheet selected lengths of said sections of said first sheet and said second sheet.

13. Apparatus for making a packaging article according to claim 12 wherein said means for separating and maintaining separation of said sections of said first sheet include a spreading member:
(a) in the path of movement of said first sheet,
(b) having a curved shape extending transverse to the path of movement of said first sheet, and
(c) with which said sections of said first sheet are in contact from one edge of said first sheet to the opposite edge of said first sheet.

14. Apparatus for making a packaging article according to claim 13 wherein said spreading member is a bow roll.

15. A packaging article made according to the method of claim 1.
